(19) United States
(12) Patent Application Publication
(10) Pub. No.: US 2006/0252621 A1
(43) Pub. Date: Nov. 9, 2006

(54) Method and apparatus for zipper registration braking

(76) Inventors: Clifton Ronald Howell, Buford, GA (US); Kevin Owen, Flowery Branch, GA (US); Joel L. Johnson, Stockbridge, GA (US); Victor Delisle, Roswell, GA (US); Michael Allan McDonald, Canton, GA (US)

Correspondence Address: Dennis M. Flaherty, Esq.;Ostrager Chong Flaherty & Broitman P. C., 250 Park Avenue, Suite 825, New York, NY, 10177-0899, US

(21) Appl. No.: 11/125,754

(22) Filed: May 9, 2005

(51) Int. Cl. B31B 1/00

(52) U.S. Cl. 493/13

(57) ABSTRACT

Methods and apparatus for stretching a plastic tape before the tape is joined in proper registration to a web of material in a machine. The apparatus comprises: means for advancing a leading portion of a flexible tape along a tape pathway; a guide that guides a lagging portion of the tape; a brake mounted to the guide and activatable to clamp a portion of the lagging portion of the tape at a first location; a sensor mounted to the guide and arranged to output a characteristic signal whenever the passage of a boundary of a structural feature of a particular type, repeatedly formed on or attached to the tape, is detected at a second location upstream of the first location; and a controller for causing the leading portion of the tape to be advanced a predetermined distance at regular spaced intervals of time and for causing the brake to clamp the lagging portion in response to the output of the characteristic signal by the sensor. The second location is selected such that the brake clamps the lagging portion while the leading portion is still being advanced, whereby a portion of the tape disposed downstream from the brake is stretched.

### BACKGROUND OF THE INVENTION

The present invention generally relates to methods and apparatus for controlling the registration of regularly reoccurring structural features on a ribbon or tape of continuous material relative to regularly reoccurring structural features on a web of continuous material during their joinder. In particular, the invention relates to methods and apparatus for registering modifications (or inserted articles) on a plastic fastener tape relative to thermoformed structures on a plastic packaging material in a thermoform-fill-seal (TFFS) machine.

During the automated manufacture of reclosable packages, a thermoplastic fastener tape unwound from a supply reel or spool is joined (e.g., by conductive heat sealing) to a web of thermoplastic packaging material. The web-to-fastener tape sealing operation can be performed either intermittently (i.e., during dwell times interspersed between intermittent advancements) or continuously (i.e., while the fastener tape and web are advancing continuously).

In cases where a fastener tape without pre-sealing and without sliders must be joined with a web of packaging material having thermoformed troughs or tubs (hereinafter “troughs”), there is a need for the fastener tape to be properly aligned with the web of film (i.e., straightness and cross-machine alignment), but there is no need to register the fastener tape relative to the web in a machine direction. This is due to the fact that the fastener tape has a constant profile along its length and thus has no structural features that need to be registered relative to the troughs thermoformed on the web of packaging material.

The fastener tape typically comprises a pair of continuous zipper strips, each zipper strip having a respective constant profile produced by extrusion. Typically, the respective zipper strip profiles have complementary shapes that allow the zipper strips to be interlocked. These closure profiles may be of the rib-and-groove variety, the interlocking-hook variety or any other suitable fastenable structures. Pre-sealing of the fastener tape involves crushing and fusing the zipper strips at spaced intervals along the fastener tape at locations where the fastener tape will be ultimately cut when each finished package is severed from the work in process.

In cases where sliders are inserted at spaced intervals along the fastener tape before the latter enters the packaging machine, it is common to combine the joinder of the zipper strips at spaced intervals with the formation of slider end stop structures on the fastener tape. Although slider end stops can be placed on or inserted in the fastener tape, it is common practice to simply deform and fuse the thermoplastic material of the zipper strips wherever slider end stops are needed. Typically, the zipper material is softened by applying ultrasonic wave energy and the thus-softened zipper material is shaped to form a slider end stop structure. Typically the slider end stop structure, when bisected, will form back-to-back slider end stops for adjacent packages. The slider end stop structure is formed at a location such that its midplane will be generally coplanar with the plane of cutting when the finished package is severed from the work in process. The plane of cutting, in turn, is typically located midway between successive thermoformed troughs in the packaging material. Thus, it is important that the slider end stop formations on the fastener tape be properly registered relative to the troughs thermoformed on the web of packaging material.

During the initial setup of a machine that joins a fastener tape to a web or webs of packaging material, the midplane of a leading slider end stop structure may be manually aligned with the cutting blade that severs the completed package from the work in process. There is a need for means to ensure that each subsequently formed slider end stop structure will ultimately arrive at a position whereat its midplane will also be generally aligned with the cutting blade. One method of accomplishing the foregoing involves the step of sensing or detecting the passage of each slider end stop structure (or each slider) at a fixed location during fastener tape advancement. This information is then used to adjust the distance by which the fastener tape is advanced in the interval between successive slider end stop formation (with concurrent slider insertion) operations.

In some applications, it is desirable to stretch each section of plastic fastener tape before it is joined to the web of packaging material. In that event, the process of registering the fastener tape relative to the web of packaging material must take into account the increase in the length of the fastener tape due to stretching. In such cases, the fastener tape is fed to the package making machine with a repeat distance that is a fraction shorter than the repeat distance of the web of packaging material to which it is joined.

There is a need for a simple, inexpensive and accurate scheme for controlling the registration of a flexible tape or ribbon (e.g., an extruded plastic fastener tape) with attachments (e.g., sliders) or formed features (e.g., slider end stop structures), as it is fed in a stretched state to a sealing station, where it is joined to a web (e.g., a web of packaging material) with formed features (e.g., thermoformed troughs). The registration control equipment should also be easy to install.

### BRIEF DESCRIPTION OF THE INVENTION

The present invention is directed to methods and apparatus for stretching a plastic tape before the tape is joined to a web of material in a machine.

One aspect of the invention is an apparatus for braking an advancing portion of a flexible and stretchable tape, comprising: means for advancing a leading portion of a flexible tape along a tape pathway; a guide that guides a lagging portion of the tape along a portion of the tape pathway; a brake mounted to the guide and activatable to clamp a portion of the lagging portion of the tape at a first location along the tape pathway; a sensor mounted to the guide and arranged to output a characteristic signal whenever the passage of a boundary of a structural feature of a particular type₊ repeatedly formed on or attached to the tape₊ is detected at a second location along the tape pathway, the second location being located upstream of the first location; and a controller for controlling the operation of the advancing means such that the leading portion of the tape is advanced a predetermined distance at regular spaced intervals of time and for controlling the operation of the brake such that the clamping operation occurs in response to the output of the characteristic signal by the sensor. The second location is selected such that the brake clamps the lagging portion while the advancing means is advancing the leading portion of the tape, whereby a portion of the tape disposed downstream from the brake is stretched.

Another aspect of the invention is a system for attaching a flexible tape to a flexible web, the tape having repeating structural features of a particular type with a repeat length that is a fraction less than a package length. The system comprises: a sealer comprising first and second sealing bars arranged on opposing sides of a first gap through which a tape pathway passes, the sealer being activatable to join a portion of the tape resident in the first gap to a portion of the web resident in the first gap; a brake arranged along the tape pathway upstream relative to the sealer and comprising first and second brake elements arranged on opposing sides of a second gap, the brake being activatable to clamp a portion of the tape resident in the second gap; means for advancing the web along a web pathway that passes through the first gap, the advancing means being activatable to advance the web along the web pathway; a sensor arranged along the tape pathway upstream relative to the brake, wherein the sensor outputs a characteristic signal whenever a boundary of a passing structural feature of the particular type is detected during tape advancement; and a controller for controlling the operation of the sealer, the brake and the advancing means during each work cycle. The controller causes the following events to occur: (a) during a dwell time of each work cycle, the sealer is activated while the advancing means are not activated; (b) during a web advancement portion of each work cycle, the advancing means are activated while the sealer is not activated, the dwell time and the web advancement portion of each work cycle being distinct periods of time, the advancing means advancing the web a distance substantially equal to the package length during the web advancement portion of each work cycle; and (c) the brake is activated in response to the output of the characteristic signal by the sensor. The sensor is located such that the brake is activated while the advancing means is still advancing the web, whereby the portion of the tape that is disposed downstream from the brake and has not yet been joined to the web by the sealer is stretched.

A further aspect of the invention is a system comprising a packaging machine, a fastener processing machine, a fastener tape comprising mutually interlocked first and second zipper strips made of flexible material that follow a pathway through the fastener processing machine and then through the packaging machine, and a controller for controlling the operation of the packaging machine and the fastener processing machine. The fastener processing machine comprises a supply reel having a portion of the fastener tape wound thereon with a paid-out portion of the fastener tape connected thereto, a first device for attaching or forming a respective structural feature of a particular type on a section of the paid-out portion of the fastener tape that is resident in a first fixed zone along the pathway at the time when the first device is activated, means for gripping a portion of the fastener tape that is resident in a second fixed zone along the pathway at the time when the gripping means are activated, tape advancing means for advancing the gripping means by a distance that is a fraction less than one package length while the gripped portion is being gripped, a sensor disposed along the pathway at a location downstream of the tape advancing means, the sensor being arranged to output a characteristic signal whenever the passage of a boundary of a structural feature of the particular type is detected in a third fixed zone along the pathway, a brake disposed at a location downstream of the sensor, the brake clamping a section of the paid-out portion of the fastener tape that is resident in a fourth fixed zone along the pathway at the time when the brake is activated, and an accumulating for taking up slack in a portion of the fastener tape disposed between the gripping means and the brake. The packaging machine comprises a supply roll having portions of a web of bag making material wound thereon with a paid-out portion of the web connected thereto, means for advancing the paid-out portion of the web by one package length, and a second device for joining respective sections of the paid-out portions of the fastener tape and the web that are resident in a fifth fixed zone along the pathway at the time when the second device is activated. The controller is programmed to control the operation of the first and second devices, the brake, the gripping means, the tape advancing means, and the web advancing means such that the following events occur: (a) the tape advancing means do not advance the gripping means while the first device is attaching or forming a structural feature of the particular type; (b) the web advancing means do not advance the web while the second device is joining respective sections of the fastener tape and the web; and (c) the brake is activated in response to the output of the characteristic signal by the sensor. The sensor is arranged such that the brake performs the clamping operation while the web advancing means is advancing the web, whereby a portion of the fastener tape disposed downstream from the brake is stretched.

Yet another aspect of the invention is a method for stretching a flexible tape of extruded plastic material comprising the following steps: (a) forming a structural feature of a particular type on or attaching a structural feature of a particular type to a lagging portion of the tape; (b) after step (a) has been performed, pulling a leading portion of the tape forward along a pathway until the leading portion of the tape has been advanced a predetermined distance, wherein the lagging portion is disposed rearward of the leading portion of the tape and advances in unison with the leading portion in the absence of a braking force applied to the lagging portion; (c) while the lagging portion of the tape is advancing during step (b), detecting the passage of a boundary of the structural feature of the particular type at a first location along the pathway; and (d) applying a braking force to a first portion of the tape present at a second location along the pathway in response to detection of the passage of the boundary at the first location, the second location being downstream relative to the first location. Step (d) occurs before the completion of step (b), whereby a second portion of the tape disposed immediately downstream of the first portion is stretched as the leading portion of the tape continues to advance.

Other aspects of the invention are disclosed and claimed below.

### BRIEF DESCRIPTION OF THE DRAWINGS

FIG. 1 is a drawing showing a front view of portions of one known type of a slider-carrying fastener tape that can be incorporated in thermoformed packages.

FIG. 2 is a drawing showing a cross-sectional view (taken along section line 2-2 indicated ion FIG. 1) of the slider-operated plastic zipper depicted in FIG. 1, except that the zipper flanges have been abbreviated in length.

FIG. 3 is a drawing showing a top view of slider-carrying fastener tape (of the type shown in FIG. 1) joined to a bottom web having thermoformed troughs.

FIG. 4 is a block diagram representing various components arranged along the zipper processing pathway of an automated apparatus in accordance with one embodiment of the invention.

FIG. 5 is a block diagram representing various components of a TFFS machine that is fed fastener tape via a tape pathway having an optical detector and a brake in accordance with one embodiment of the invention.

FIG. 6 is a drawing showing an isometric view of a fiber optic sensor being used to detect a zone where the zipper flanges are fused together in accordance with one embodiment of the invention.

FIGS. 7-9 are drawings showing side, front and top views of a zipper registration brake assembly in accordance with an alternative embodiment of the invention.

FIG. 10 is a block diagram showing a subsystem for providing a programmed logic controller with counting signals during advancement of the packaging material in a TFFS machine, which signals are used in conjunction with feedback from a sensor that detects reoccurring structural features on the advancing fastener tape.

Reference will now be made to the drawings in which similar elements in different drawings bear the same reference numerals.

### DETAILED DESCRIPTION OF THE INVENTION

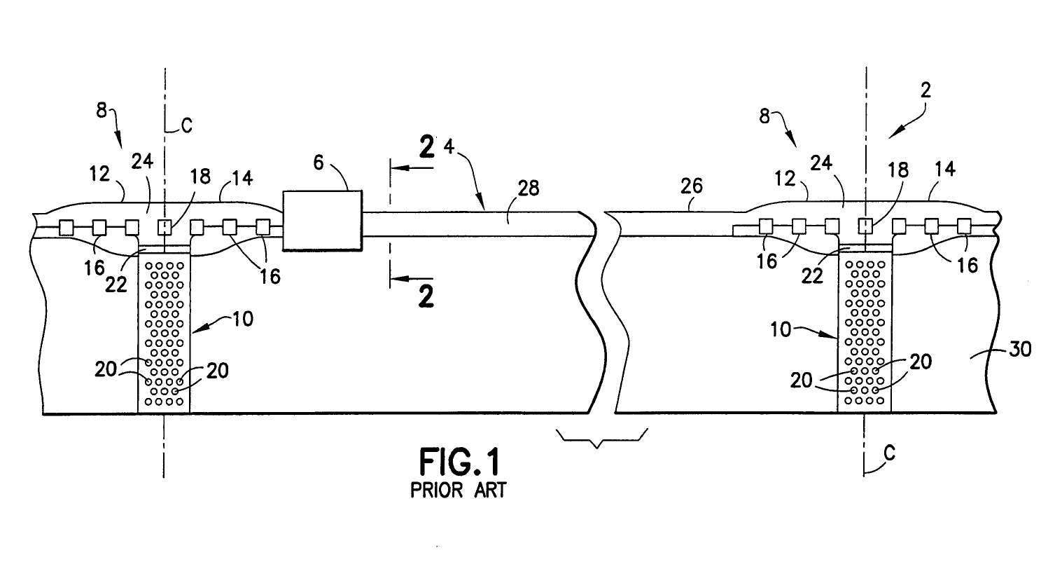

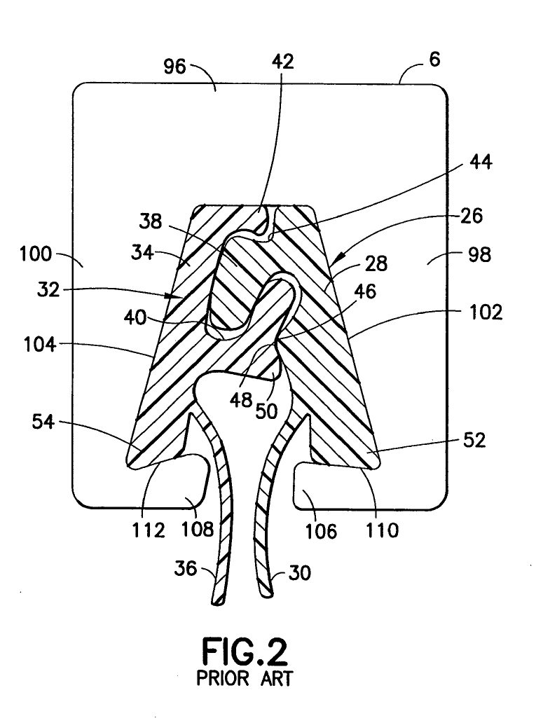

For the purpose of describing various methods for stretching a section of fastener tape before that section is joined to a web of packaging material in an FFS or other packaging machine, an exemplary fastener tape having sliders inserted at spaced intervals therealong will be described with reference to FIGS. 1 and 2. Several methods and apparatus for stretching will then be described with reference to this exemplary slider/fastener tape assembly. However, it should be understood that the invention is not limited in its application to the particular slider/fastener tape assembly depicted in FIGS. 1 and 2. The broad scope of the invention will be apparent from the claims that follow this detailed description.

The slider/fastener tape assembly depicted in FIGS. 1 and 2 may be manufactured using a process involving concurrent formation of slider end stop structures and sealing of zipper flanges at spaced intervals along a pair of interlocked flanged zipper strips unwound from a roll or spool. The flanged zipper strips are typically produced by extrusion so that initially they have a constant profile along their length. The zipper strips have complementary closure profiles and respective zipper flanges formed during the extrusion process. In the embodiments disclosed herein, the forming/sealing operation is carried out by applying ultrasonic wave energy to the zipper material. However, instead of ultrasonic wave energy, thermal or conduction heat sealing methods may be used. Sufficient energy (ultrasonic or thermal) is applied to the zipper or closure profiles in a first zone and to the zipper flanges in a second zone to soften and merge the plastic material in both zones, the merged material forming a zone of fusion upon cooling. Each zone of fusion has a plane of symmetry, the planes of symmetry being spaced, for some applications, along the zipper at intervals approximately_equal to one package length. Each zone of fusion is also shaped to form a pair of slider end stops that are joined at their backs₊ until when the zipper is cut along the plane of symmetry in the bag making or packaging machine, as described in detail below.

The operations described in the preceding paragraph, can also be employed for sliderless flanged zippers. In this case the closure profiles are deformed and fused to form zipper pre-seals instead of slider end stops. As previously described, “pre-sealing” involves flattening the zipper prior to merging with the packaging material at a position ultimately corresponding to the package edge. The pre-sealing operation facilitates sealing the sides of the package in the area of the zipper.

In accordance with one method of manufacturing the slider/fastener tape assembly seen in FIGS. 1 and 2, the interlocked zipper strips are advanced intermittently and then the forming/sealing operation is repeated during each dwell time between successive advancements. Typically, sliders are inserted at a station downstream from the ultrasonic stomping station. The resulting slider/fastener tape assembly comprises a chain of connected zipper lengths, each zipper length having a respective slider. This chain can be wound on a spool for storage or transport, or the chain can be fed directly to a packaging machine.

In the embodiments of the invention disclosed herein, slider end stops are formed and the zipper flanges are sealed before the fastener tape is joined to film in a packaging machine. A section of a slider/fastener tape assembly 2 is depicted in FIG. 1. The assembly 2 comprises a fastener tape 4 having a multiplicity of sliders 6 (only one of which is shown in FIG. 1) mounted thereon. Each slider 6 is of the straddling type, i.e., the slider has no separating finger and thus requires that slider end stops be provided at the ends of each zipper section.

The fastener tape 4 comprises a pair of interlockable zipper strips 26 and 32 (see FIG. 2) having respective flanges 30 and 36 extending from respective closure profiles 28 and 34. In the view of FIG. 1, only the zipper strip 26 is visible. The closure profiles of the two zipper strips have complementary (i.e., interlocking) shapes. Although FIG. 2 shows a rib and groove arrangement, the closure profiles of the zipper strips may take any form. For example, the zipper may comprise interlocking rib and groove elements or alternating hook-shaped closure elements. The zipper strips 26 and 32 are made of translucent or transparent thermoplastic material. The preferred zipper material is polyethylene or polypropylene.

To facilitate opening and closing of each zipper after it has been installed in the mouth of a package or bag, each package-length section of the fastener tape is provided with a respective straddling slider 6, as shown in FIGS. 1 and 2. The slider 6 can be top-loaded onto the zipper without having to disengage the profiled structures at the loading point since the slider does not make use of a separating finger. The closure profiles 28 and 34 are engaged, i.e., interlocked, with each other as the slider travels in the closing direction. Conversely, the closure profiles 28 and 34 are disengaged from each other as the slider travels in the opening direction. The slider 6 may be made in multiple parts and welded together or the parts may be constructed to be snapped together. The slider may also be of one-piece construction. The slider can be made using any desired method, such as injection molding. The slider can be molded from any suitable plastic, such as nylon, polypropylene, polystyrene, acetal, polyketone, polybutylene terephthalate, high-density polyethylene, polycarbonate, or ABS. Typically, the slider is made of opaque material, in contrast to the zipper, which is translucent or transparent.

FIG. 2 depicts a closing end of the slider 6, with the zipper shown in cross section. The closing end is shaped to force the closure profiles 28 and 34 into engagement when the slider 6 travels in the closing direction. During slider travel in the closing direction, the closing end is the trailing end of the slider. As shown in FIG. 2, the slider 6 straddles the zipper and has a top wall 96 from which a first side wall 98 and a second side wall 100 depend. The first side wall 98 has an inner surface 102 and the second side wall 100 has an inner surface 104. The slider inner surfaces 102 and 104 are divergent with respect to each other in the same manner as the outer surfaces of the closure profiles, and are spaced to push the closure profiles 28 and 34 into engagement as the slider 6 is moved along the zipper in the closing direction. The slider side walls 98 and 100 are respectively provided with retaining shoulders 106 and 108 having upper surfaces 110 and 112 that mate with the lower surfaces of the rails 52 and 54 of the closure profiles. These mating surfaces may be tapered to maximize their pull-off resistance.

Opening of the zipper is achieved when the slider 6 is moved in the opening direction. Although not shown, at the opening end of the slider, the slider side walls have inner surfaces that are substantially parallel, rather than divergent as at the closing end (shown in FIG. 2). As the slider is moved in the opening direction and the slider side wall inner surfaces change from the “A” configuration of surfaces 102 and 104 (see FIG. 2) to a substantially parallel configuration of surfaces (not shown) at the opening end of the slider, the rails 52 and 54 are forced towards each other, thereby forcing the fulcrum members 46 and 48 into a tighter relationship and causing the rib 38 and groove 40 to pivot oppositely about the fulcrum 50. Simultaneously, a retaining shoulder (not shown) on the slider side wall 98 forces the male profile upwardly, while a shoulder (not shown) forces the female profile downwardly, causing the convex male fulcrum member 46 (see FIG. 2) to cam upwardly along the concave female fulcrum member 48. Thus, the resulting action is a simultaneous pivoting of the closure profiles 28 and 34 oppositely about the fulcrum 50 and an upward translation of the closure profile 28 relative to the closure profile 34, resulting in disengagement of the profiled structures. A cavity (not shown in FIG. 2) in the slider top 96 accommodates the upward translation of the male closure profile 28.

During bag or package manufacture, the top marginal portions of the front and rear walls of the receptacle (not shown in FIGS. 1 and 2) of the bag or package are respectively sealed to the zipper flanges 30 and 36 by a conventional conduction heat sealing technique. Alternatively, the front and rear walls may be extended beyond the zones of wall/zipper flange joinder and joined to each other at the top marginal portions to form a header that shrouds the slider/zipper assembly. The receptacle may be made from any suitable film material, including thermoplastic film materials such as low-density polyethylene, substantially linear copolymers of ethylene and a C3-C8 alpha-olefin, polypropylene, polyvinylidene chloride, mixtures of two or more of these polymers, or mixtures of one of these polymers with another thermoplastic polymer. The person skilled in the art will recognize that this list of suitable materials is not exhaustive. Although not intended in a limitative sense, it is noted that the thickness of the film is preferably 2 mils or less.

For the slider/fastener tape assembly partially depicted in FIG. 1, a multiplicity of zones 8 of fused zipper material are formed, at spaced intervals along a lengthwise direction, by the application of heat and pressure to the zipper material. The heat may be generated by the application of ultrasound wave energy as the fastener tape is pressed between a horn and an anvil of an ultrasonic welding assembly, e.g., of the type disclosed in disclosed in U.S. patent application Ser. No. 10/439,847, entitled “Method and Apparatus for Sealing Flanges and Deforming Profiles of Plastic Zipper”. Each zone of fusion 8 is generally T-shaped. Each slider 6 is mounted to a respective unfused section disposed between successive zones of fusion 8. Each zone of fusion 8 comprises a first area wherein the closure profiles of the interlocked zipper strips are fused to each other and deformed, and a second area wherein the zipper flanges of the interlocked zipper strips are fused to each other and deformed.

The aforementioned first area of the zone of fusion 8 extends in the lengthwise direction and forms the top of the T shape. During the forming/sealing operation, some of the plastic material of the zipper profiles is deformed and pushed upward to form the extended hump seen in FIG. 1. Also, some of the plastic material of the zipper profiles in the zone of fusion is deformed and pushed downward. In the forming process, a generally flattened surface 24 is formed in each zone of fusion 8. In addition, a row of spaced indentations is formed on one side of the zone of fusion 8 in the first area where the profiles are fused. A central indentation 18 is disposed along a plane of symmetry of the zone of fusion 8, which plane is indicated by the dashed line designated by the letter “C” in FIG. 1. Other indentations 16 (in this example, three on each side of the central indentation) are formed along a line generally perpendicular to line C, as seen in FIG. 1. These indentations are impressed on only one side of the fastener tape by respective teeth formed on the ultrasonic horn, as fully disclosed in U.S. patent application Ser. No. 10/439,847. The teeth act as vertical energy directors to penetrate the heat into the center of the zipper directly into the fulcrum area of the profiles.

When the zipper is later cut along line C, the deformed and fused zipper profiles form respective slider end stops 12 and 14 on separate packages. In this sense, the first area of the zone of fusion comprises back-to-back end stops. These end stops prevent the slider from sliding off the ends of the zipper when the slider reaches the closed or fully opened position. Such end stops perform dual functions, serving as stops to prevent the slider from going off the end of the zipper and also holding the two zipper profiles together to prevent the bag from opening in response to stresses applied to the profiles through normal use of the bag.

The aforementioned second area of the zone of fusion 8 extends transverse to the lengthwise direction and forms the stem of the T shape. During the forming/sealing operation, some of the plastic material of the zipper flanges is deformed and merged to form a flange seal 10. The flange seal 10 comprises an array of dimples 20. Alternatively, an array of mutually parallel spaced grooves extending generally parallel to the line C may be formed. The dimples (or grooves) 20 are impressed on the same side of the zipper that the above-described indentations are formed. The dimples and indentations are formed and the surface 24 is flattened in one operation. A generally planar transitional surface 22 is also formed between the flattened surface 24 and the flange seal 10. In a later stage of manufacture, respective webs (or folded sides of the same web) of the packaging material will be sealed to the opposite faces of each flange seal and will be sealed to each other along side seams aligned with the flange seals 10.

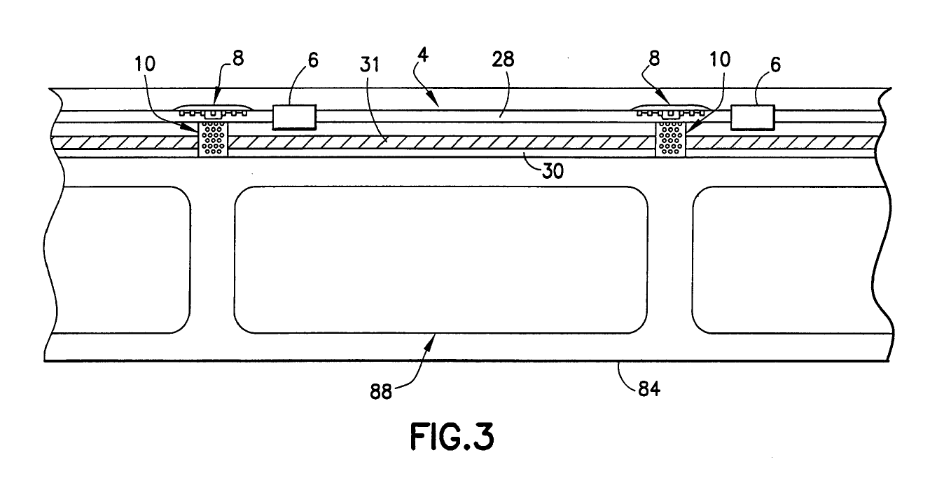

For the purpose of illustration, various embodiments of the invention will be disclosed hereinafter in which stretched and correctly registered sections of a slider/fastener tape assembly are fed by automated equipment to a TFFS machine. FIG. 3 shows the slider/fastener tape assembly 2 joined to a web 84 having thermoformed troughs 88. For the purpose of this disclosure, it should be assumed that the fastener tape of assembly 2 was joined to web 84 in a stretched state. The assembly 2 is shown lying on its side on top of the web 88 with the lowermost flange heat sealed to the web in a band-shaped zone of joinder indicated by the hatched region 31. For the purpose of illustration, the zone of joinder 31 has been indicated as viewed through the transparent zipper flanges, the uppermost zipper flange 30 being visible in FIG. 3. To facilitate joinder of the slider/fastener tape assembly 2 to the thermoformed web 84, the stretched zipper strips must be accurately registered relative to the web. More precisely, the zones 8 in which the zipper strips are fused together must be properly positioned relative to the thermoformed troughs 88. Still more precisely, the centerlines (not shown) of the zones of zipper fusion 8 need to be respectively substantially aligned with lines (not shown) that bisect the not-thermoformed portions of web 84 disposed between successive thermoformed troughs 88.

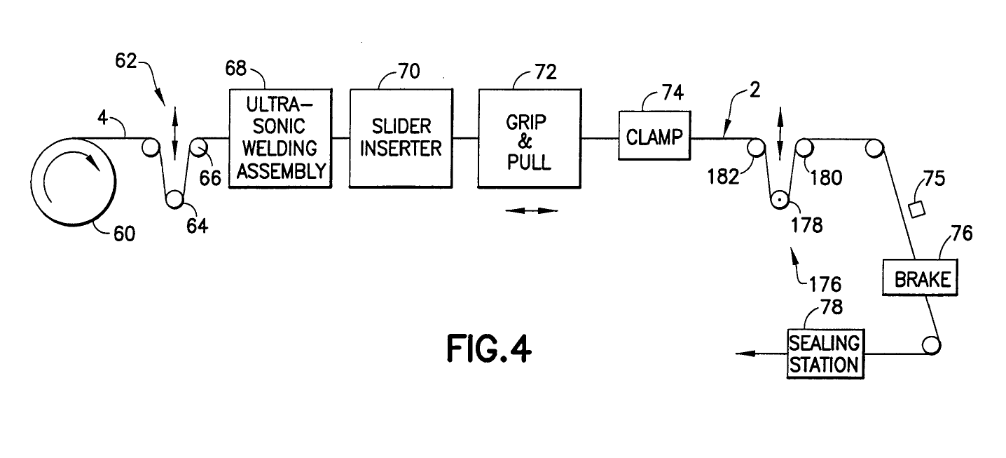

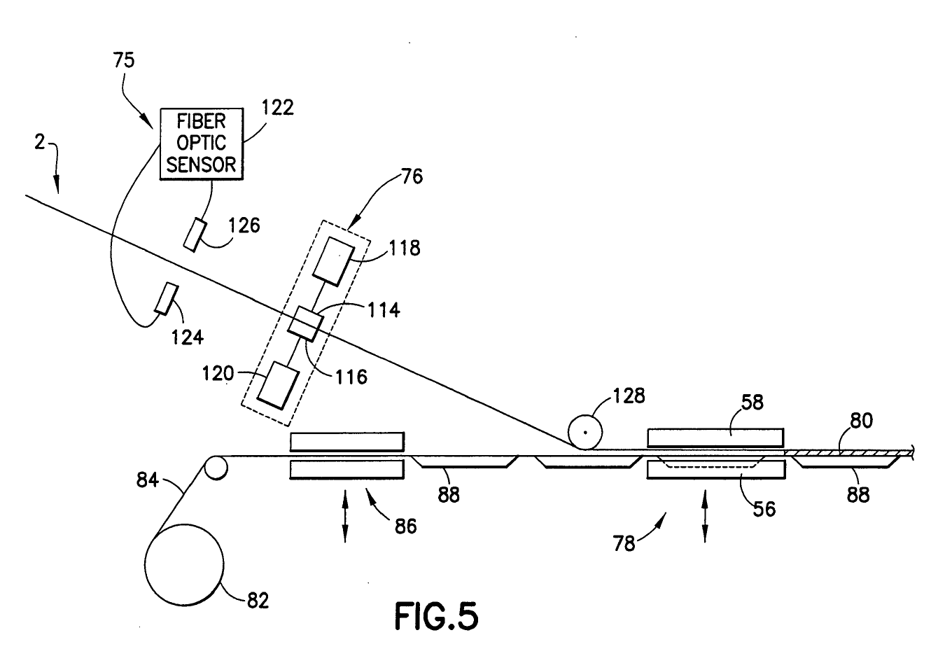

In accordance with one embodiment of the present invention, each thermoformed package is manufactured with a slider-operated zipper. A system in accordance with that embodiment combines the fastener tape processing system shown in FIG. 4 with a TFFS machine. Only one component of the TFFS machine, namely, a sealing station 78, where the fastener tape is joined to the thermoformed bottom web of packaging material, is shown in FIG. 4. Various known components of the TFFS machine that are disposed upstream of the sealing station 78 are shown in FIG. 5. The known TFFS machine components disposed downstream of the sealing station are not shown.

Referring now to FIG. 4, a length of thermoplastic fastener tape 4, comprising, e.g., respective lengths of a pair of interlocked flanged zipper strips (e.g., of the type shown in FIG. 2), is unwound from a supply reel of a powered unwind stand 60 and passed through an accumulator 62. The accumulator comprises a weighted dancer roller 64 that is supported on a shaft, which shaft is freely vertically displaceable (as indicated by the double-headed arrow in FIG. 4) along a slotted support column (not shown). The weight of the dancer roller 64 takes up any slack in the portion of the fastener tape suspended between the supply reel 60 and a guide roll 66. A sensor (not shown in FIG. 4) may be provided for detecting the vertical position of the dancer roller 64. The feedback signal from that sensor is used by a PLC (not shown in FIG. 4) to control the motor that powers the unwind stand 60, thereby controlling the payout of fastener tape 4.

An ultrasonic welding assembly 68 is disposed downstream of the guide roll 66. During each dwell time, the plastic zipper strips are softened and/or melted and shaped by the ultrasonic welding assembly in a respective zone. The ultrasonically welded plastic material of the respective zipper strips is shaped to form a respective slider end stop structure in each zone upon cooling. The deformed portions of the zipper strips are also fused together in each zone. Each slider end stop structure will form back-to-back slider end stops when the end stop structure is cut during bag formation. The ultrasonic welding assembly 68 may comprise an ultrasonic transducer acoustically coupled to a horn, the horn being opposed by an anvil (not shown in FIG. 4). Either the horn or the anvil or both reciprocate between retracted and extended positions. The ultrasonic transducer is activated and the horn and/or anvil is extended in response to activation signals from the PLC (not shown in FIG. 4). While a portion of the fastener tape is being pressed between the horn and anvil, the horn emits ultrasonic wave energy at an intensity and frequency designed to soften and/or melt the thermoplastic fastener tape during each dwell time. The horn and/or anvil may be provided with recesses designed to form the softened and/or molten thermoplastic material into a slider end stop structure. When the softened/melted material cools, the material of the respective zipper strips fuses together to form a zipper joint.

The ultrasonically welded and shaped portion of fastener tape is then advanced to the next station, comprising a conventional slider insertion device 70 that inserts a respective slider (not shown in FIG. 4) onto each repeat-length section of fastener tape during each dwell time. Each slider is inserted adjacent a respective slider end stop structure on the continuous fastener tape. The slider insertion device comprises a reciprocating pusher that is alternately extended and retracted by an air cylinder (not shown in FIG. 4). The pusher of the slider inserter 70 is extended in response to activation signals from the PLC (not shown in FIG. 4). As the pusher extends, it pushes the slider onto the fastener tape. The other parts of such a slider insertion device, including a track along which sliders are fed, are well known and will not be described in detail herein.

During each dwell time, the fastener tape 4 is gripped by a clamp 74, so that the unwound length of fastener tape spanning the distance between guide roller 66 and clamp 74 is stationary during ultrasonic welding and slider insertion. The clamp 74 may comprise a clamping gripper assembly of the type disclosed in U.S. patent application Ser. No. 11/081,369 and entitled “Apparatus for Repeatedly Advancing Fastener Tape a Predetermined Distance”. This clamping gripper assembly comprises a pair of oppositely moving gripper arms (not shown). When the clamping gripper assembly is in a closed state, respective gripper pads on the gripper arms grip a portion of the straight zipper material. The gripper arms are actuated by a double-acting parallel motion air cylinder (not shown in FIG. 4), which is controlled by the aforementioned PLC. The clamping gripper assembly may comprise a carriage that is slidable along a straight rail to allow adjustment of its longitudinal position. But once the adjustment has been made, the clamping gripper assembly is secured relative to the rail, e.g., by means of a thumbscrew, so that the clamping gripper assembly is stationary during machine operation.

At the end of each dwell time, the fastener tape is gripped by a grip-and-pull mechanism 72 and then released by the clamp 74. Also, the ultrasonic horn or anvil or both are retracted and the pusher of the slider inserter is retracted, so that the length of fastener tape is free to advance. Then the grip-and-pull mechanism 72 is operated to pull the unwound length of fastener tape (ultrasonically stomped and carrying sliders) forward a desired distance. As will be explained in detail below, in accordance with one embodiment, the stroke of the grip-and-pull mechanism 72 is adjusted to be a fraction less than the repeat length (i.e., package length) of the TFFS machine. During pulling of the portion of the fastener tape disposed upstream of the clamp 74, the most recently inserted slider leaves the slider insertion zone and the most recently formed slider end stop structure is moved from the ultrasonic welding station to the slider insertion zone. Thus, the stroke of the grip-and-pull mechanism 72 determines the repeat length (i.e., the length per repeating structural feature) of the unstretched fastener tape. The clamp 74 is then closed again, following which the grip-and-pull mechanism 72 is opened and returned to its home position.

The grip-and-pull mechanism 72 may comprise an indexing gripper assembly that is linearly displaced by an indexing drive mechanism as disclosed in the aforementioned U.S. patent application Ser. No. 11/081,369. The indexing gripper assembly comprises a carriage that rides on a straight rail. The indexing drive mechanism comprises a lead screw driven to rotate by a servomotor under the control of the PLC. The indexing gripper assembly further comprises a nut threadably coupled to the lead screw and rigidly coupled to the carriage. The nut converts the rotation of the lead screw into linear displacement of the carriage. The indexing gripper assembly further comprises a pair of oppositely moving gripper arms. When the indexing gripper assembly is in a closed state, respective gripper pads on its gripper arms grip a section of the fastener tape that is disposed upstream of the clamped portion. The gripper arms of the indexing gripper assembly are actuated by a double-acting parallel motion air cylinder, which is again controlled by the PLC.

Downstream of the open clamp 74, the advancing fastener tape is accumulated by an accumulator 176. The accumulator 176 comprises a weighted dancer roller 178 that is supported on a shaft, which shaft is freely vertically displaceable (as indicated by the double-headed arrow in FIG. 4) along a slotted support column (not shown). The weight of the dancer roller 178 takes up any slack in the portion of fastener tape suspended between the guide rolls 180 and 182.

Downstream from the accumulator 176, the slider/fastener tape assembly 2 passes in front of a sensor 75 on its way to a sealing station 78 in the TFFS machine. A zipper registration brake 76 is disposed between the sensor 75 and the sealing station 78 along the tape process pathway. As the slider/fastener tape assembly 2 is pulled toward the sealing station 78 by the web advancing mechanism (not shown) of the TFFS machine, the sensor 75 is employed to detect a repeating structural feature (e.g., the zipper flange seal 10 or the slider 6) on the fastener tape.

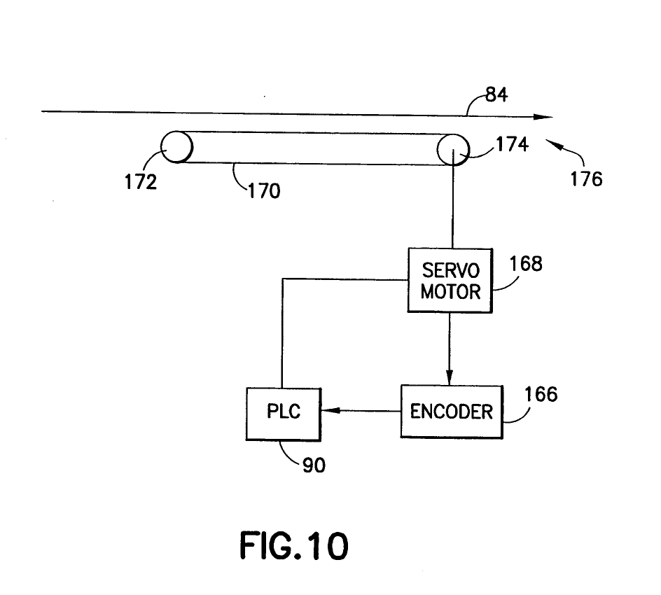

In the disclosed embodiments, the sensor 75 is an optical detector. When the structural feature is detected, the sensor 75 outputs a characteristic signal to a PLC (not shown in FIG. 4), which processes the signal information to derive the precise instant when the leading edge of repeating structural feature (e.g., each slider or each zipper flange seal) was detected. As will be explained later, the PLC uses that information, with other information from the TFFS machine (described later with reference to FIG. 10), to adjust the stroke of the grip-and-pull mechanism 72. In addition, the PLC activates the braking device 76 in response to the characteristic signal from the sensor 75. The braking device 76 clamps a portion of the fastener tape while another portion of the fastener tape disposed downstream of the clamped portion (and passing through the sealing station 78) continues to be pulled forward by the TFFS machine, thereby causing that downstream portion of the fastener tape to be stretched (including the portion to be sealed to the web in the next fastener tape-to-bottom web sealing operation performed by the sealing station 78). The sensor 75 and the braking device 76 are located so that the section of the fastener tape disposed at the sealing station (and destined to become the zipper on a single package) is stretched to match the web repeat length (i.e., the package length). During the next dwell time, the section of the slider/fastener tape assembly 2 that is resident at the sealing station 78 will be sealed in place to the stationary bottom web, as seen in FIG. 3. Then the sealer 78 opens and the TFFS machine indexes. The brake 76 can be released any time after the sealer 78 has closed and before the TFFS machine is indexed.

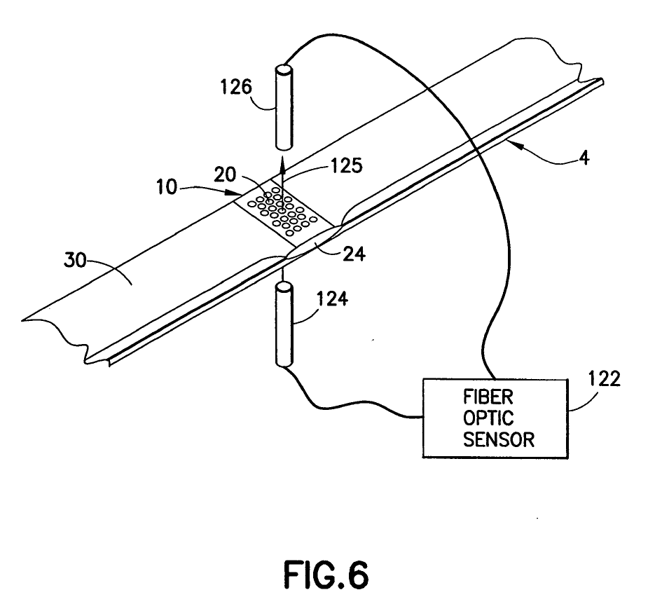

Various known components of the TFFS machine that are disposed upstream of the sealing station 78 are shown in FIG. 5. FIG. 5 also shows a sensor 75 in the form of a fiber optic sensor 122 having transmitting and receiving optical fibers 124 and 126 (described in more detail hereinafter with reference to FIG. 6); and a brake 76 in the form of a pair of brake pads 114 and 116 mounted to the ends of the piston rods of respective air cylinders 118 and 120. Advancement of the slider/fastener tape assembly 2 into the TFFS machine is facilitated by a guide roller 128. In accordance with this embodiment, both air cylinders 118 and 120 are activated to press the brake pads 114 and 116 together (as shown in FIG. 5), thereby clamping the intervening portions of the zipper flanges of the fastener tape. This clamping is in response to the fiber optic sensor 122 outputting a characteristic signal indicating that a particular structural feature of the slider/fastener tape assembly 2 has been detected at the location where the light beam emitted from the optical fiber 124 impinges on the slider/fastener tape assembly. However, as will be explained below, an optical detector other than a fiber optic sensor can be employed. Also, instead of both brake pads reciprocating, a brake can be provided in which one brake pad reciprocates while the other remains stationary.

Still referring to FIG. 5, during web and tape advancement, the bottom web 84 of packaging material is unrolled from a supply roll 82 and pulled through a thermoforming station 86. A respective trough 88 for product is formed at the thermoforming station by deep-drawing using vacuum and heat during each dwell time. One trough is formed for each package-length section of packaging material, but the trough is surrounded by a perimeter of packaging material that is not thermoformed, including a lateral margin where a package-length section of the slider/fastener tape assembly 2 will be attached. The thermoformed bottom web is advanced to the sealing station 78, where a respective package-length section of fastener tape is joined to each package-length section of the web.

More specifically, a respective section of stretched fastener tape is joined to the bottom web 84 by conventional conduction heat sealing during each dwell time. This may be accomplished by a reciprocating heated sealing bar 56 arranged below the bottom web 84. The sealing bar 56 reciprocates between retracted and extended positions under the control of the PLC. In the extended position, the heated (i.e., “hot”) sealing bar 56 presses against a stationary unheated (i.e., “cold”) bar 58, with the flanges of the zipper strips and the non-thermoformed margin of the bottom web sandwiched therebetween. When sufficient heat and pressure are applied, the bottom web 84 is joined to the flange of the lower zipper strip by conductive heat sealing. To prevent seal-through of the zipper flanges, just enough heat is conducted into the zipper material from the hot sealing bar. Alternatively, a separating plate may be interposed between the flanges during sealing, or the zipper flanges may have a laminated construction comprising sealant layers on the exterior surfaces or non-sealant layers on the interior surfaces.

As a result of the joinder of certain sections of the fastener tape to the bottom web 84 of the packaging material, the section of the fastener tape disposed immediately upstream of the sealing station 78 will be pulled forward during each intermittent advancement of the bottom web 84. When the brake 76 clamps the fastener tape, the bottom web will still be moving, thereby stretching the section of fastener tape suspended between the brake 76 and the fastener tape/bottom web zone of joinder most recently made by the sealing station 78.

Preferably the sensor 75 (seen in FIG. 4) is an optical detector that produces light which interacts with the structural features of interest during tape advancement. Several embodiments of suitable optical detecting means are disclosed in U.S. patent application Ser. No. 11/______, filed concurrently herewith and entitled “Methods for Sensing Structural Features on Moving Fastener Tape”. Suitable optical detecting means include, but are not limited to, a laser thru-beam photoelectric sensor (e.g., the LX2 Series commercially available from Keyence Corporation); a laser scan micrometer (e.g., the LS-5000 Series commercially available from Keyence Corporation); a fiber-optic sensor (e.g., the FS-V20 Series commercially available from Keyence Corporation); or a laser displacement sensor (e.g., the LK Series commercially available from Keyence Corporation or the laser displacement sensor disclosed in U.S. Pat. No. 6,624,899). In general, optical detection of the leading edge or boundary of the structural feature of interest involves transmitting light that impinges on the fastener tape or other elongated continuous structure and then detecting portions of the transmitted light after it has interacted with the leading edge or boundary. Alternatively, mechanical or electro-mechanical detecting means could be employed.

Various structural features (or boundaries thereof) of the slider/fastener tape assembly 2 shown in FIG. 1 can be optically detected, such as the zipper flange seals 10, the slider end stop formations 12 and 14, and the slider 6. It should be appreciated, however, that the optical detection methods disclosed hereinafter can be employed with sliders and fastener tapes constructed differently than the construction shown in FIGS. 1 and 2.

A method of optically detecting structural features formed on or attached to a fastener tape in accordance with the embodiment depicted in FIG. 5 is shown in FIG. 6. The fastener tape 4 is the same as that previously described with reference to FIG. 1, except that no sliders are shown in FIG. 6. This method employs a fiber optic sensor 122 that has an output port connected to an optical fiber 124 and an input port connected to an optical fiber 126. The optical fibers 124 and 126 must be fixed in respective positions on opposite sides of the zipper flanges of the moving fastener tape 4, with the respective distal portions of the optical fibers aligned so that portions of a beam of light exiting the transmitting optical fiber 124 and passing through the zipper flanges will enter the receiving optical fiber 126 and be returned to the fiber optic sensor 122. The fiber optic sensor 122 may comprise a light-emitting diode for outputting an LED beam at the output port to which the transmitting optical fiber 124 is connected and a photodetector for detecting the portion of the transmitted LED beam 125 that passes through the fastener tape and enters the receiving optical fiber 126 (disregarding the ambient light that enters the receiving optical fiber for purposes of this discussion). The photodetector inside the fiber optic sensor 122 converts impinging light into an electrical signal having an amplitude proportional to the intensity of the impinging light, which electrical signal is then amplified. The LED beam emitted from the transmitting optical fiber 124 has a constant intensity, whereas the intensity of the light entering the receiving optical fiber 126 will depend on the portion of the transmitted LED beam that passes through the fastener tape, which in turn will depend on the structure of the fastener tape at the location where the LED beam passes through.

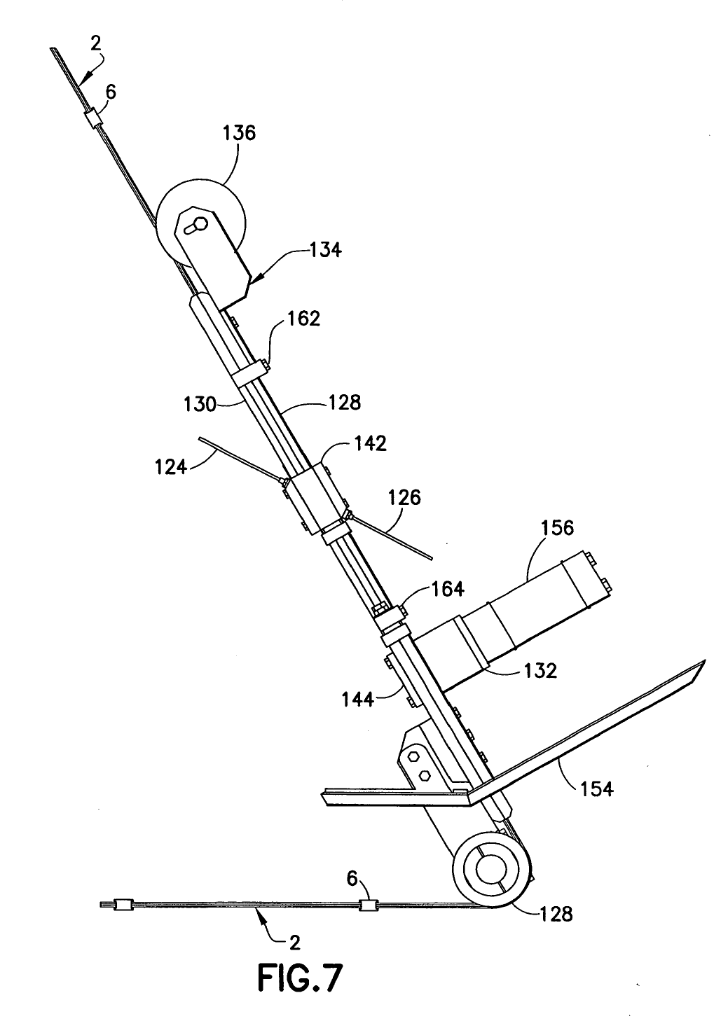

In the implementation depicted in FIG. 6, the LED beam is targeted at the zipper flanges of the fastener tape and is oriented generally perpendicular to the plane of the zipper flanges. However, it is preferred that the LED beam be directed at a non-perpendicular angle (e.g., 30 degrees from the plane of the zipper flanges, as seen in FIG. 7, to be described hereinafter). As the fastener tape advances along a process pathway, the structure of the fastener tape exposed to the LED beam changes. Over the major portion of each repeat-length section of the fastener tape, the LED beam is transmitted through unjoined sections of two zipper flanges that are separated by an air gap, the translucence of these unjoined sections of the zipper flanges being unaltered along the length of the zipper. In contrast, over a minor portion of each repeat-length section of the fastener tape, i.e., across each flange seal 10, the LED beam is transmitted through a section where the two zipper flanges are fused together. The fused zipper flanges have a translucence that is less than the translucence of the unaltered zipper flanges, resulting in a decrease in the intensity of the light arriving at the photodetector inside the fiber optic sensor 122. The fiber optic sensor 122 has a digital display for indicating the intensity of the received light and also outputs an electrical signal representing the received light intensity to a PLC (not shown in FIG. 6). The stream of electrical feedback to the PLC contains information indicating the instants of time when the leading and lagging edges respectively of the moving flange seal 10 cross the path of the transmitted LED beam. The PLC receives similar information for each successive flange seal that crosses the LED beam.

Using the foregoing optical detection technique, the PLC is able to acquire information representing the instants of time when the leading edges of successive flange seals cross the path of the transmitted LED beam. However, this information alone does not indicate the distance separating the leading edges of successive flange seals. Additional means may be provided for determining the distance that the section of fastener tape with flange seals has traveled in the intervals between successive flange seal leading edge detection events. An example of such means will be disclosed later herein with reference to FIG. 10.

In accordance with a variation of the optical detection technique depicted in FIG. 6, the optical fibers 124 and 126 can be positioned so that the sliders on the moving fastener tape will cross the path of the LED beam. In this case, the opaque slider will completely block the LED beam, so that the stream of electrical feedback to the PLC contains information indicating the instants of time when the leading and lagging edges respectively of the moving slider cross the path of the LED beam. Before and after the slider is blocking the LED beam, at least a portion of the transmitted LED beam will reach the receiving optical fiber 126. For example, the optical fibers could be positioned such that the LED beam passes through the closure profiles when the slider is absent. However, since the slider extends above and below the closure profiles, a person skilled in the art will readily appreciate that the LED beam could be aimed at a location above or below the closure profiles while still impinging on each passing slider.

An apparatus for braking the slider/fastener tape assembly in accordance with another embodiment of the invention is shown in detail in FIGS. 7-9. In the view seen in FIG. 7, the slider/fastener tape assembly 2 is traveling downward at an angle from left to right, and then passes around a guide roller 128 to travel leftward while a leading portion of the fastener tape (not shown in FIG. 7) is being pulled by the web advancement means (the leading portion of the fastener tape is joined to the web and moves in unison with the web) incorporated in the TFFS machine (not shown). The apparatus is mounted to the machine frame via a horizontally disposed circular tubular support member 188 and a brake mounting weldment 152 that is rigidly attached to the support member 188. The brake mounting weldment 152 supports a rigid structure comprising upper and lower slider guides 128 and 130 that are fastened together to form a channel that guides each slider as the slider/fastener tape assembly advances. A drip pan 154, which prevents oil or other liquid from the equipment dripping onto the packaging web below (not shown), is also fastened to the brake mounting weldment 152.

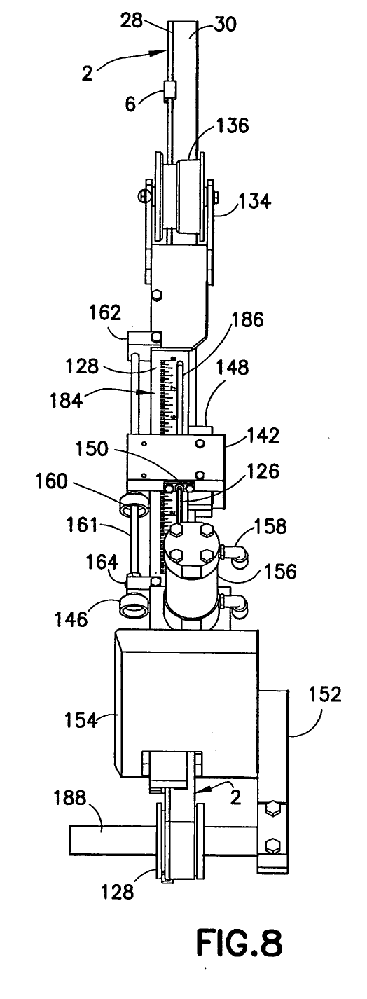

To facilitate advancement of the slider/fastener tape assembly 2, a pair of guide rollers 136 and 128 are provided at the beginning and the end of the slider guide. The upper guide roller 136 is mounted to the slider guide by means of a roller bracket weldment 134. The lower guide roller 128 is rotatably mounted to the support member 188 (see FIG. 8) by bearing means.

The slider guide constrains the sliders so that they displace along a straight line with the orientation of each slider being maintained generally constant during that displacement. The slider guide has a generally C-shaped cross section. The upper and lower slider guides 128 and 130, when fastened together, form a channel. The opposing faces of the distal ends of the upper and lower slider guides form an opening in the side of the slider guide that communicates with the channel. The channel and opening both run the length of the slider guide. The slider guide channel has a cross section that allows passage of successive sliders. Sufficient clearance is provided that the sliders move freely along the channel without jamming. Also the aforementioned side opening is disposed and sized to allow portions of the mutually opposing zipper flanges to penetrate and protrude out of the opening. The inlet end of the slider guide preferably has chamfered internal surfaces to facilitate entry of each slider into the slider guide channel.

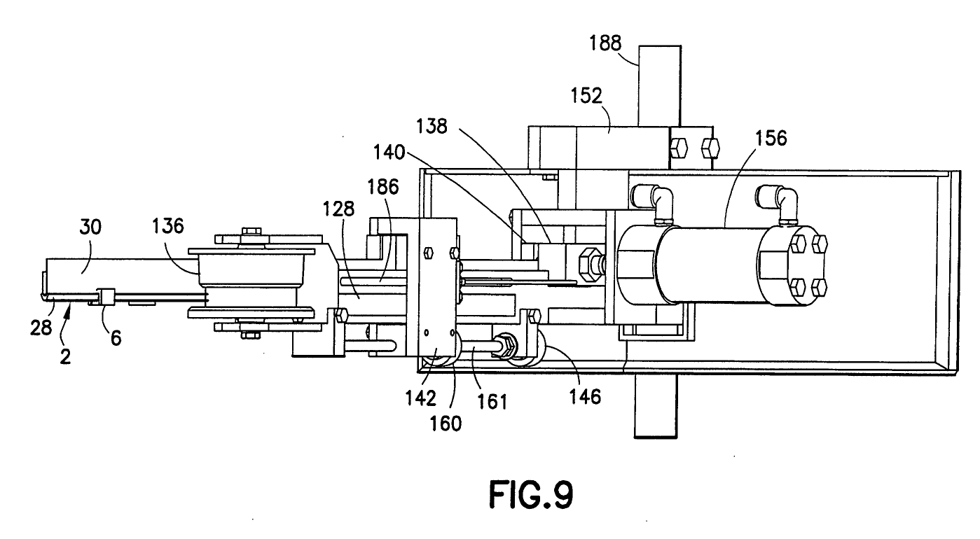

The brake is mounted to the slider guide by means of a brake base plate 144 and a cylinder mount weldment 134. The brake comprises an air cylinder 156, which is attached to the cylinder mount weldment 134; a clamping brake pad 138 (see FIG. 9), which is mounted to the distal end of the piston rod of the air cylinder 156; and a stationary brake pad 140 (see FIG. 9), which is supported by the brake base plate 144. The clamping brake pad 138 is preferably made of silicone rubber, while the stationary brake pad 140 is preferably made of plastic. When the brake is activated as previously described, the air cylinder 156 is activated to extend the clamping brake pad 138, thereby clamping the intervening portions of the zipper flanges of the fastener tape between the stationary and clamping brake pads. The air cylinder 156 has respective ports 158 for coupling to a source of pressurized air. When pressurized air is provided to one port, the clamping brake pad is extended; when pressurized air is provided to the other port, the clamping brake pad is retracted.

Referring to FIG. 8, it can be seen that the upper slider guide 128 also has a slot 186 that runs parallel to the slider guide channel. The lower slider guide has a similar slot. These longitudinal slots provide windows through which the light beam emitted from the end of an optical fiber 124 (disposed below the lower slider guide 130) can pass and be received by an optical fiber 126 (disposed above the upper slider guide 128). Both optical fibers are coupled to an optical fiber sensor of the type previously described, which is not mounted to the slider guide. The ends of the optical fibers 124 and 126 are held in a fixed aligned relationship and at a 30-degree angle relative to the slider guide by respective bushings of a sensor mount 142, which is adjustably mounted to the slider guide. Only bushing 150 for the optical fiber 126 is shown in FIG. 8.

In accordance with the embodiment depicted in FIGS. 7-9, the slots in the slider guide and the ends of the optical fibers are positioned laterally so that the transmitted light beam will impinge upon the zipper flange seal (item 10 in FIG. 1) of the fastener tape. A flange guide 148 (see FIG. 8), mounted to the slider guide, is provided to constrain the position and planarity of the flexible zipper flanges within the field of view of the fiber optic sensor, thereby ensuring that the characteristic signal produced in response to detection of the leading edge of the zipper flange seal will be reproducible and will not be produced when portions of the zipper flanges outside the zipper flange seals are detected. Alternatively, the slots in the slider guide and the ends of the optical fibers could be positioned laterally so that the transmitted light beam impinges upon the passing sliders or other structural features.

As previously mentioned, the position of the sensor mount 142 along the length of the slider guide can be adjusted. A reference scale 184 is provided on the top surface of the upper slider guide 128 to aid the system operator, during set-up of the system, to correctly locate the sensor mount. As part of the set-up process, the zipper zones of fusion on the portion of the slider/fastener tape assembly disposed at the sealing station in the TFFS machine must be manually registered with non-thermoformed portions of the bottom web. Then the sensor mount 142 must be correctly positioned relative to the nearest structural feature of interest, taking into account the fact that the fastener tape, which is unstretched during set-up, will be stretched during actual operation. When the system is started, the system operator will immediately check the first packages off the machine. Any discrepancies can be compensated for by further adjustments to the position of the sensor mount along the slider guide.

As best seen in FIG. 8, the sensor mount 142 is threadably coupled to a sensor adjustment screw 161, which is rotatable relative to and supported by a pair of adjustment screw brackets 162 and 164. As the sensor adjustment screw 161 is turned in one direction or the other, the sensor mount 142 linearly displaces up or down along the slider guide. A locking nut 160 is threadably coupled to the sensor adjustment screw 161. When the locking nut 160 abuts the sensor mount 142, the sensor adjustment screw 161 cannot be turned. An adjustment knob 146 is attached to the lower end of the sensor adjustment screw 161 for adjusting the position of the sensor mount 142 when the locking nut 160 is unlocked.

As will be explained in greater detail below, adjusting the position of the sensor mount 142 will also move the locations of the zipper flange seals. Since the registration brake creates tension in the fastener tape, several indexes must be processed for the placement to become constant after an adjustment. To move the sensor mount 142, first the locking nut 160 is loosened and then the knob 146 at the end of the sensor adjustment screw 161 is turned until the sensor mount 142 reaches the desired position, as determined with reference to the scale 184. The sensor mount is then locked in place by tightening the locking nut 160.

A PLC controls the operation of the web advancing means such that a leading portion of the fastener tape is advanced a predetermined distance at regular spaced intervals of time. The PLC also controls the operation of the brake such that the clamping operation occurs in response to the output by the optical detector of a characteristic signal indicating the presence of a boundary of the structural feature (e.g., a zipper flange seal) of interest. The brake is released some time before the next activation of the web advancing means. The position of the sensor mount 142 is selected such that the brake clamps the intervening portion of the fastener tape while the web advancing means is still advancing a leading portion of the fastener tape in the TFFS machine, whereby a portion of the fastener tape disposed downstream from the brake is stretched.

The PLC also uses the information from the optical detector, along with other information from the TFFS machine (described later with reference to FIG. 10), to adjust the stroke of the grip-and-pull mechanism 72 (see FIG. 4) in a manner that, in conjunction with the braking function, maintains proper registration of the slider end stop structures relative to the thermoformed troughs 88 of the bottom web 84 (see FIG. 5). In response to a sensor feedback characteristic signal indicating the instant when the leading edge of the attached or modified structural feature was detected, the PLC correlates that event with a count signal representing the position of the concurrently advancing bottom web 84 in the TFFS machine. Each leading edge detection event is correlated with a respective count, thereby enabling the PLC to compare the distance between successive leading edges to the distance by which the bottom web has advanced, which distance is directly proportional to the count

A subsystem for providing the count signal (representing the advancement of the bottom web) to a PLC 90 is generally depicted in FIG. 10. The bottom web 84 may be intermittently advanced by conventional means 176. The portion of the bottom web 84 paid out from the bottom web supply roll (item 82 in FIG. 5) is advanced by a pair of endless chain belts 170 (only one of which is depicted in FIG. 10, the other being directly behind) that circulate on respective sprocket wheels 172 and 174, the latter of which is driven as explained below. In a known manner, spring-loaded clamps (not shown in FIG. 10) are mounted to both chain belts 170 for clamping the lateral margins of the bottom web 84. As the chain belts 170 circulate, the clamps carried thereon pull the bottom web through the sealing station (78 in FIG. 5). The structural details concerning the various components of the web advancing means 176, such as spring-loaded clamps, respective bearing-mounted sprocket wheels and respective engagement discs associated with the sprocket wheels and serving to open the spring-loaded clamps, are disclosed in full in U.S. Pat. No. 4,826,025 and will not be described in detail herein. Alternatively, a pair of drive belts that bear against the lateral margins of the bottom web could be used in place of the chain belts with spring-loaded clamps.

Still referring to FIG. 10, rotation of the sprocket wheel 174 is driven by a servomotor 168, which is controlled by the PLC 90. During operation of the TFFS machine, the PLC 90 is programmed to activate the servomotor 168 at regular intervals interspersed with dwell times. During each activation, the servomotor 168 causes the bottom web 84 to be advanced by a constant indexing distance equal to one package length. The shaft of servomotor 168 is coupled to an encoder 166 that encodes shaft rotation by outputting a number proportional to the angle of rotation. That number, which is also proportional to the distance that the bottom web has advanced, is provided as feedback to the PLC 90. Provided that the servomotor 168 is activated in a repeatable manner, the number output by the encoder 166 will increase by the same amount for each intermittent advancement of the bottom web. For example, the encoder count might increase by 1000 for each package-length advancement of the bottom web. This increasing count will be provided as feedback from the encoder 166 to the PLC 90.

The PLC 90 is programmed to adjust the distance between the leading edges of successive slider end stop structures (or other modifications) or sliders (or other attachments) to compensate for any variation from one package length. Referring to FIG. 4, the PLC accomplishes this by adjusting the forward stroke of the grip-and-pull mechanism 72 as a function of feedback from the sensor 75.

In accordance with one implementation, the PLC controls all of the activatable components depicted in FIGS. 4 and 5. More specifically, the PLC is programmed to control various solenoids that open various strategically placed valves that, when open, connect a source of compressed air to various air cylinders. These air cylinders in turn respectively actuate movement of various components represented in FIG. 4, such as the following: (a) an indexing gripper assembly of the grip-and-pull mechanism 72; (b) a stationary gripper assembly of the clamp 74; (c) a horn (or anvil) of the ultrasonic welding assembly 68; and (d) a pusher of the slider insertion device 70. The PLC also controls a waveform generator that supplies an electrical waveform to an ultrasonic transducer, which transducer in turn outputs acoustic waves that are delivered to the fastener tape by the aforementioned horn of the ultrasonic welding assembly 68. In addition, the PLC controls various servomotors including the following: (a) a servomotor (not shown in FIG. 4) that drives rotation of a lead screw of the grip-and-pull mechanism 72, which rotation is converted into linear displacement of the indexing gripper assembly by means of the type previously described: (b) a servo motor (not shown in FIG. 4) that drives rotation of the power unwind stand 60; and (c) the servomotor 94 (shown in FIG. 10) that drives advancement of the bottom web through the packaging machine. The PLC (or a separate PLC) also controls the operations of the thermoforming station 86 and the various sealing stations, the sealing station 78 for joining the bottom web to the fastener tape being the only sealing station depicted in FIG. 5.

Furthermore, as previously explained in detail, the PLC receives feedback from the sensor 75 (see FIG. 4) and the encoder 166 (see FIG. 10), and then controls the servomotor that drives rotation of the lead screw of the grip-and-pull mechanism 72 (see FIG. 4). By controlling the number of revolutions of the servomotor, the PLC can adjust the forward stroke of the grip-and-pull mechanism 72 to advance the fastener tape by a desired distance. As previously explained, the adjustment is a function of the discrepancy between the distance separating successive leading edges of the slider end stop structures (or the sliders), which distance is detected by the sensor 75, and the distance by which the bottom web is advanced, which is reflected in the change in the count from the encoder 166 as the result of each bottom web advancement, taking into account the percentage that the zipper is stretched before sealing.

The various components that move between retracted and extended positions (e.g., slider pusher, ultrasonic horn, clamp, sealing bar, etc.) may be coupled to respective double-acting pneumatic cylinders. Operation of the cylinders is controlled by the PLC, which selectively activates the supply of fluid to the double-acting cylinders in accordance with an algorithm or logical sequence. Hydraulic cylinders can be employed as actuators in place of air, i.e., pneumatic, cylinders. A person skilled in the art of machinery design will readily appreciate that displacing means other than a cylinder can be used to displace components such as the horn of the ultrasonic welding assembly and the pusher of the slider inserter. For the sake of illustration, such mechanical displacement devices include rack and pinion arrangements or lead screw/coupling nut assemblies, rotation of the pinion or lead screw being driven by an electric motor.

While the invention has been described with reference to preferred embodiments, it will be understood by those skilled in the art that various changes may be made and equivalents may be substituted for members thereof without departing from the scope of the invention. In addition, many modifications may be made to adapt a particular situation to the teachings of the invention without departing from the essential scope thereof. Therefore it is intended that the invention not be limited to the particular embodiment disclosed as the best mode contemplated for carrying out this invention, but that the invention will include all embodiments falling within the scope of the appended claims.

As used in the claims, the term “controller” means a programmed logic controller, an electronic computer, a central processing unit, a microchip, a microcontroller or other programmable device or a system of interconnected and synchronized control units, each control unit comprising a programmed logic controller, an electronic computer, a central processing unit, a microchip, a microcontroller or other programmable device. Also, in the absence of explicit language in any method claim setting forth the order in which certain steps should be performed, the method claims should not be construed to require that steps be performed in the order in which they are recited.

1. An apparatus for braking an advancing portion of a flexible and stretchable tape, comprising:
means for advancing a leading portion of a flexible tape along a tape pathway;
a guide that guides a lagging portion of said tape along a portion of said tape pathway;
a brake mounted to said guide and activatable to clamp a portion of said lagging portion of said tape at a first location along said tape pathway;
a sensor mounted to said guide and arranged to output a characteristic signal whenever the passage of a boundary of a structural feature of a particular type, repeatedly formed on or attached to said tape, is detected at a second location along said tape pathway, said second location being located upstream of said first location; and
a controller for controlling the operation of said advancing means such that said leading portion of said tape is advanced a predetermined distance at regular spaced intervals of time and for controlling the operation of said brake such that said clamping operation occurs in response to the output of said characteristic signal by said sensor,
wherein said second location is selected such that said brake clamps said lagging portion while said advancing means is advancing said leading portion of said tape, whereby a portion of said tape disposed downstream from said brake is stretched.

2. The apparatus as recited in claim 1, wherein said sensor comprises an optical detection device.

3. The apparatus as recited in claim 1, wherein said sensor comprises a fiber optic sensor.

4. The apparatus as recited in claim 1, further comprising a sensor mount mounted to said guide, wherein said sensor comprises first and second optical fibers having respective ends supported by said sensor mount, said end of said second optical fiber being arranged to receive light emitted from said end of said first optical fiber.

5. The apparatus as recited in claim 4, further comprising a reference scale having indicators spaced along a line parallel to said guide, wherein the position of said sensor mount on said guide is adjustable relative to said scale.

6. The apparatus as recited in claim 1, wherein said tape has successive sliders mounted thereto at spaced intervals therealong, each structural feature of said type detected by said sensor being a respective one of said sliders, and said guide comprises a channel that guides successive sliders during advancement of said tape.

7. The apparatus as recited in claim 1, wherein said tape comprises first and second zipper strips that are interlocked with each other, said first zipper strip comprising a first closure profile and a first zipper flange connected to said first closure profile, said second zipper strip comprising a second closure profile interlocked with said first closure profile and a second zipper flange connected to said second closure profile, and each structural feature of said type detected by said sensor is a respective structural modification of said interlocked first and second zipper strips, and said guide comprises a channel that guides said first and second zipper flanges during advancement of said tape.

8. The apparatus as recited in claim 1, further comprising means for adjusting the position of said sensor along the length of said guide.

9. The apparatus as recited in claim 8, further comprising a reference scale having indicators arranged at spaced intervals along a line that is parallel to the path traveled by said slider during adjustment of its position along said guide.

10. The apparatus as recited in claim 1, wherein said brake comprises a first braking element that is fixed and a second braking element that reciprocates under the control of said controller, said first and second braking elements clamping said tape therebetween during a clamping operation.

11. A system for attaching a flexible tape to a flexible web, said tape having repeating structural features of a particular type with a repeat length that is a fraction less than a package length, comprising:
a sealer comprising first and second sealing bars arranged on opposing sides of a first gap through which a tape pathway passes, said sealer being activatable to join a portion of said tape resident in said first gap to a portion of said web resident in said first gap;
a brake arranged along said tape pathway upstream relative to said sealer and comprising first and second brake elements arranged on opposing sides of a second gap, said brake being activatable to clamp a portion of said tape resident in said second gap;
means for advancing said web along a web pathway that passes through said first gap, said advancing means being activatable to advance said web along said web pathway;
a sensor arranged along said tape pathway upstream relative to said brake, wherein said sensor outputs a characteristic signal whenever a boundary of a passing structural feature of said particular type is detected during tape advancement; and
a controller for controlling the operation of said sealer, said brake and said advancing means during each work cycle such that the following events occur:
during a dwell time of each work cycle, said sealer is activated while said advancing means are not activated;
during a web advancement portion of each work cycle, said advancing means are activated while said sealer is not activated, said dwell time and said web advancement portion of each work cycle being distinct periods of time, said advancing means advancing said web a distance substantially equal to said package length during said web advancement portion of each work cycle; and
said brake is activated in response to the output of said characteristic signal by said sensor, and said sensor being located such that said brake is activated while the advancing means is still advancing said web, whereby the portion of said tape that is disposed downstream from said brake and has not yet been joined to said web by said sealer is stretched.

12. The system as recited in claim 11, wherein said first braking element is fixed and said second braking element reciprocates under the control of said controller.

13. The system as recited in claim 11, further comprising a guide that guides said tape along a portion of said tape pathway from a point upstream of said sensor to a point downstream of said brake, wherein said sensor and said brake are mounted to said guide.

14. The system as recited in claim 13, further comprising means for adjusting the position of said sensor along said guide.

15. The system as recited in claim 14, further comprising a reference scale having indicators arranged at spaced intervals along a line that is parallel to the path traveled by said slider during adjustment of its position along said guide.

16. The system as recited in claim 11, wherein said structural feature of said particular type is a slider.

17. The system as recited in claim 11, wherein said structural feature of said particular type is a zone where first and second zipper flanges of said fastener tape are fused together.

18. The system as recited in claim 1, wherein said sensor comprises an optical detection device.

19. The system as recited in claim 13, further comprising a sensor mount mounted to said guide, wherein said sensor comprises first and second optical fibers having respective ends supported by said sensor mount, said end of said second optical fiber being arranged to receive light emitted from said end of said first optical fiber.

20. A system comprising a packaging machine, a fastener processing machine, a fastener tape comprising mutually interlocked first and second zipper strips made of flexible material that follow a pathway through said fastener processing machine and then through said packaging machine, and a controller for controlling the operation of said packaging machine and said fastener processing machine, wherein:
said fastener processing machine comprises a supply reel having a portion of said fastener tape wound thereon with a paid-out portion of said fastener tape connected thereto, a first device for attaching or forming a respective structural feature of a particular type on a section of the paid-out portion of said fastener tape that is resident in a first fixed zone along said pathway at the time when said first device is activated, means for gripping a portion of said fastener tape that is resident in a second fixed zone along said pathway at the time when said gripping means are activated, tape advancing means for advancing said gripping means by a distance that is a fraction less than one package length while said gripped portion is being gripped, a sensor disposed along said pathway at a location downstream of said tape advancing means, said sensor being arranged to output a characteristic signal whenever the passage of a boundary of a structural feature of said particular type is detected in a third fixed zone along said pathway, a brake disposed at a location downstream of said sensor, said brake clamping a section of the paid-out portion of said fastener tape that is resident in a fourth fixed zone along said pathway at the time when said brake is activated, and an accumulating for taking up slack in a portion of said fastener tape disposed between said gripping means and said brake;
said packaging machine comprises a supply roll having portions of a web of bag making material wound thereon with a paid-out portion of said web connected thereto, means for advancing the paid-out portion of said web by one package length, and a second device for joining respective sections of the paid-out portions of said fastener tape and said web that are resident in a fifth fixed zone along said pathway at the time when said second device is activated; and
said controller is programmed to control the operation of said first and second devices, said brake, said gripping means, said tape advancing means, and said web advancing means such that the following events occur:
(a) said tape advancing means do not advance said gripping means while said first device is attaching or forming a structural feature of said particular type;
(b) said web advancing means do not advance said web while said second device is joining respective sections of said fastener tape and said web; and
(c) said brake is activated in response to the output of said characteristic signal by said sensor, wherein said sensor is arranged such that said brake performs said clamping operation while said web advancing means is advancing said web, whereby a portion of said fastener tape disposed downstream from said brake is stretched.

21. A method for stretching a flexible tape of extruded plastic material comprising the following steps:
(a) forming a structural feature of a particular type on or attaching a structural feature of a particular type to a lagging portion of said tape;
(b) after step (a) has been performed, pulling a leading portion of said tape forward along a pathway until said leading portion of said tape has been advanced a predetermined distance, wherein said lagging portion is disposed rearward of said leading portion of said tape and advances in unison with said leading portion in the absence of a braking force applied to said lagging portion;
(c) while said lagging portion of said tape is advancing during step (b), detecting the passage of a boundary of said structural feature of said particular type at a first location along said pathway; and
(d) applying a braking force to a first portion of said tape present at a second location along said pathway in response to detection of the passage of said boundary at said first location, said second location being downstream relative to said first location,
wherein step (d) occurs before the completion of step (b), whereby a second portion of said tape disposed immediately downstream of said first portion is stretched as said leading portion of said tape continues to advance.
